(19) United States
(12) Patent Application Publication
(10) Pub. No.: US 2024/0212004 A1
(43) Pub. Date: Jun. 27, 2024

(54) UNDERSTANDING CUSTOMER'S INTENT FROM CONVERSATIONS IN AN ONLINE MARKETPLACE

(71) Applicant: Honda Motor Co., Ltd., Tokyo (JP)

(72) Inventor: MATT KOMICH, Denver, CO (US)

(21) Appl. No.: 18/069,691

(22) Filed: Dec. 21, 2022

(51) Int. Cl. G06Q 30/02

(52) U.S. Cl. CPC G06Q 30/0281

(57) ABSTRACT

An electronic device and method for understanding customer's intent from conversations is disclosed. The electronic device controls a customer device to render a marketplace User Interface (UI) associated with an online reseller marketplace. The electronic device receives, from the customer device, an input that includes a selection of a vehicle from a listing on the marketplace and initiates a chat session between a customer associated with the input and an agent. The electronic device records a conversation between the customer and the agent for a duration of the session. The conversation includes queries associated with the vehicle. The electronic device updates a score as measure of an intent of the customer to purchase the vehicle based on a textual analysis of the conversation and controls a display device associated with the agent to render insight information associated with the conversation. The insight information is rendered based on the updated score.

### BACKGROUND

Private buyers and sellers of used vehicles typically communicate, especially early on in conversation via a third-party. In some cases, parties may not trust each other and may prefer to communicate via chat or anonymous email address through a third-party marketplace. To boost chances of a quick sale or acquisition, certain parties may list or search on the most prominent marketplaces. Despite this, parties may not trust each other and may be hesitant to exchange personal contact information due to a poor user reputation on these markets, where the parties may have witnessed frauds and unwanted interactions.

Private sellers of a used vehicle may create an online listing that typically includes photo and video media of the vehicle, vehicle details, specifications, price details, and the like. The sellers may post on online marketplaces where buyers typically look for used vehicles. After posting, the sellers may wait for inquiries or requests from buyers. In a typical interaction, a buyer may chat with a seller or may email to seller to ask questions about the vehicle in the online listing. The buyer may chat or email to learn about the vehicle and decide if the listing is a good option for purchase. Many sellers have issues with buyers who make an inquiry with no real interest in purchasing the vehicles. Such buyers ask questions to the sellers out of curiosity or to see if the seller accepts a low offer on the vehicles.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, an electronic device for understanding customer's intent is disclosed. The electronic device may include circuitry that may control a customer device to render a marketplace User Interface (UI) associated with an online reseller marketplace. From the customer device, the circuitry may receive an input that includes a selection of a vehicle from a listing of vehicles on the marketplace UI and may initiate a chat session between a customer associated with the input and an agent associated with the vehicle. The circuitry may record a conversation between the customer and the agent for a duration of the chat session. The conversation may include a set of customer queries associated with the vehicle. Thereafter, the circuitry may update a score as a measure of an intent of the customer to purchase the vehicle based on a textual analysis of the conversation and may control a display device associated with the agent to render insight information associated with the conversation. The insight information may be rendered based on the updated score.

According to another embodiment of the disclosure, a method for understanding a customer's intent is disclosed. The method may include controlling a customer device to render a marketplace User Interface (UI) associated with an online reseller marketplace and receiving, from the customer device, an input that includes a selection of a vehicle from a listing of vehicles on the marketplace UI. The method may further include initiating a chat session between a customer associated with the input and an agent associated with the vehicle and recording a conversation between the customer and the agent for a duration of the chat session. The conversation may include a set of customer queries associated with the vehicle. The method may further include updating a score as a measure of an intent of the customer to purchase the vehicle based on a textual analysis of the conversation and controlling a display device associated with the agent to render insight information associated with the conversation. The insight information may be rendered based on the updated score.

According to another embodiment of the disclosure, a non-transitory computer-readable medium is provided. The non-transitory computer-readable medium may have stored thereon computer implemented instructions that, when executed by a system, causes the system to execute operations. The operations may include controlling a customer device to render a marketplace User Interface (UI) associated with an online reseller marketplace and receiving, from the customer device, an input that includes a selection of a vehicle from a listing of vehicles on the marketplace UI. The operations may further include initiating a chat session between a customer associated with the input and an agent associated with the vehicle. The operations may further include recording a conversation between the customer and the agent for a duration of the chat session. The conversation may include a set of customer queries associated with the vehicle. Thereafter, the operations may include updating a score as a measure of an intent of the customer to purchase the vehicle based on a textual analysis of the conversation and controlling a display device associated with the agent to render insight information associated with the conversation. The insight information may be rendered based on the updated score.

### BRIEF DESCRIPTION OF THE DRAWINGS

FIG. 1 is a block diagram that illustrates an exemplary network environment for understanding a customer's intent from conversations in an online marketplace, in accordance with an embodiment of the disclosure.

FIG. 2 is a block diagram that illustrates an exemplary electronic device of FIG. 1, in accordance with an embodiment of the disclosure.

FIGS. 3A and 3B are diagrams that illustrate exemplary interactions between a customer and an agent associated with a vehicle, in accordance with an embodiment of the disclosure.

FIGS. 4A and 4B are diagrams that illustrate an exemplary scenario for a display of insight information associated with an exemplary conversation between a customer and an agent, in accordance with an embodiment of the disclosure.

FIG. 5 is a diagram that illustrates an exemplary scenario for generation of insight information, in accordance with an embodiment of the disclosure.

FIG. 6 is a diagram that illustrates an exemplary scenario for display of insight information based on past conversations of a customer, in accordance with an embodiment of the disclosure.

FIG. 7 is a flowchart that illustrates exemplary operations for understanding a customer's intent, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in the disclosed electronic device and method for understanding customer's intent from conversations in an online marketplace. Exemplary aspects of the disclosure may provide an electronic device (such as a computer, a laptop, a mobile phone, a smartphone, and so on) that may be configured to control a customer device (such as a computer, a laptop, a mobile phone, a smartphone, and so on) to render a marketplace User Interface (UI) associated with an online reseller marketplace. The marketplace UI may include a customer UI and a seller UI. The customer UI may be adapted for a customer associated with a customer device. The seller UI may be adapted for a seller associated with a display device. In an embodiment, the seller UI and the customer UI may be different. In another embodiment, the seller UI and the customer UI may include some common features and some different features. From the customer device, the circuitry may receive an input that includes a selection of a vehicle from a listing of vehicles on the marketplace UI. A chat session may be initiated between a customer associated with the input and an agent (such as a chatbot or a person who is a seller of the vehicle) associated with the vehicle. For a duration of the chat session, a conversation between the customer and the agent may be recorded. The conversation may include a set of customer queries associated with the vehicle. Thereafter, the circuitry may update a score as a measure of an intent of the customer to purchase the vehicle based on a textual analysis of the conversation. The circuitry may control a display device associated with the agent to render insight information associated with the conversation based on the updated score. For example, the insight information may include a message “40% of the customers that ask questions about history of the vehicle, purchase the vehicle they are inquiring about”.

Private vehicles sellers and customers often start conversations with one another through a third party. In some situations, parties (e.g., customers and sellers) may not trust one another and may choose to interact through a third-party marketplace using a chat feature or an anonymous email address. Private sellers of used vehicles may post an online listing that typically includes images and videos of the vehicle, information about vehicles, vehicle features, vehicle pricing information, and other information. The sellers may publish ads on websites where customers frequently shop for used vehicles. The sellers may wait for requests or queries from customers after posting. A customer may contact or chat with a seller to ask questions about the vehicle in the online listing in a typical conversation. The customer may chat or email to learn about the vehicle and decide if the listing is a good option for purchase.

Many sellers struggle with inquiries from customers who have no actual interest in buying the vehicles. These customers may inquire about the vehicles from sellers out of curiosity or to find out if the sellers take lowball offers for the vehicles. Such customers may be referred to as non-serious customers. A non-serious customer may often bring up the price of the vehicle early on in conversation and may ask to meet the seller in a very short time frame (e.g., same day or next day). In some instances, the non-serious customer may not be prompt or timely when responding to the seller in a conversation. In contrast, a serious customer may not bring up the price early on in the conversation. The serious customer may typically ask questions about the seller's personal history with the vehicle, locations where the vehicle was driven, specifics about tires or other vehicle components, reasons for which the seller is ready to sell the vehicle, maintenance history, past owners, and the like. Sellers typically complain of an amount of time that the sellers waste in selling a vehicle privately.

In order to address the above-mentioned issues, the present disclosure provides an electronic device that may assist a seller of a vehicle to determine an intent of a customer in purchasing the vehicle. The intent may be determined from a conversation between the customer and the seller and may indicate if a customer is a serious buyer or a non-serious buyer. The present disclosure may use a machine learning model and one or more natural language processing (NLP) techniques to analyze the conversation and determine a customer's seriousness for a vehicle. The model may be trained on data related to multiple conversations. Once trained, the model may know what customers typically ask at different stages in a conversation (e.g., early, middle, or late stage of a conversation) and whether questions in such stages are common for a serious customer.

The electronic device may use the machine learning model and the NLP technique to monitor a progression of a conversation. For example, a customer may make requests during the course of conversation that may lead to next steps in the process of purchasing a vehicle. Such requests may include, for example, a question in which the customer asks the seller if the vehicle can be inspected and/or seen by a mechanic, a question in which the customer asks the seller to meet for a test drive, a question in which the customer asks the seller about a vehicle history, or a question in which the customer asks for documentation related to vehicle maintenance. The electronic device may implement an agent (e.g., a chatbot) to help the seller with insights from the conversations and with highlights for customer questions that may be relevant for the seller.

Reference will now be made in detail to specific aspects or features, examples of which are illustrated in the accompanying drawings. Wherever possible, corresponding, or similar reference numbers will be used throughout the drawings to refer to the same or corresponding parts.

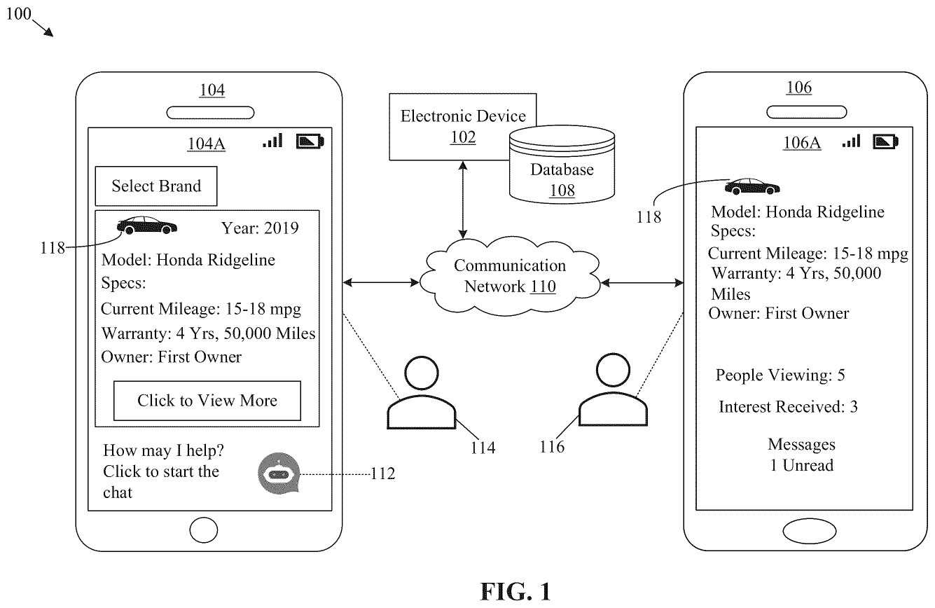

FIG. 1 is a block diagram that illustrates an exemplary network environment for understanding a customer's intent from conversations in an online marketplace, in accordance with an embodiment of the disclosure. With reference to FIG. 1, there is shown a network environment 100. The network environment 100 may include an electronic device 102, a customer device 104, a customer user interface (UI) 104A, a display device 106, a seller UI 106A, a database 108, and a communication network 110. The electronic device 102 may communicate with the customer device 104 and the display device 106 through the communication network 110. The network environment 100 may further include a customer 114 associated with the customer device 104, a seller 116 associated with the display device 106, an agent such as a chatbot 112 for replying to customer queries on behalf of the seller 116, and a vehicle 118 displayed on the customer device 104 or the display device 106.

The electronic device 102 may include suitable logic, circuitry, interfaces, and/or code that may be configured to provide an online platform (i.e., a reseller marketplace) that enables sellers (such as the seller 116) to list vehicles for sale and customers to view the list, converse with the sellers, and/or purchase the vehicles. The electronic device 102 may record a conversation between the customer 114 and an agent (for example, the chatbot 112 or the seller 116 of the vehicle 118) for a duration of a chat session and may perform a textual analysis of the conversation to provide insight information on the display device 106 of the agent or the seller 116. The electronic device 102 may update a score as a measure of an intent of the customer 114 to purchase the vehicle 118 based on the textual analysis of the conversation. Examples of the electronic device 102 may include, but are not limited to, a computing device, a desktop, a personal computer, a laptop, a computer workstation, a tablet computing device, a smartphone, a cellular phone, a mobile phone, a consumer electronic (CE) device having a display, a wearable display, a server, or an edge device connected to a user's home network or an organization's network.

The customer device 104 may include suitable logic, circuitry, interfaces, and/or code that may render a marketplace UI associated with an online reseller marketplace. The customer UI 104A on the customer device 104 may be used to display a version of the marketplace UI that is adapted for the customer device 104. By way of example, and not limitation, the customer UI 104A may be used to display at least a listing of vehicles, a chat session between the agent (such as the seller 116 or the chatbot 112) and the customer 114, and information associated with the listing of vehicles. For the vehicle 118, the information may include at least one of a specification of features in the vehicle 118, historical usage details of the vehicle 118, performance parameters of the vehicle 118, details of a current owner of the vehicle 118, warranty and insurance details for the vehicle 118, price information for the vehicle 118, and the like. Examples of the customer device 104 may include, but are not limited to, a computing device, a desktop, a personal computer, a laptop, a computer workstation, a tablet computing device, a smartphone, a cellular phone, a mobile phone, a consumer electronic (CE) device having a display, a television (TV), a wearable display, a head mounted display, a digital signage, or an edge device connected to a user's home network or an organization's network.

The display device 106 may include suitable logic, circuitry, interfaces, and/or code that may be controlled by the electronic device 102 to render insight information associated with the conversation. The seller UI 106A displayed on the display device 106 may be a version of the marketplace UI that is adapted for the display device 106 associated with the seller 116. By way of example, and not limitation, the seller UI 106A may be used to display an information associated with a listing of the vehicle 118 of the seller 116, a chat session between the agent (such as the seller 116 or the chatbot 112) and the customer 114, and insight information associated with the conversation. In an embodiment, the seller UI 106A and the customer UI 104A may be different. In another embodiment, the seller UI 106A and the customer UI 104A UI may include some common features and some different features. Examples of the display device 106 may include, but are not limited to, a computing device, a desktop, a personal computer, a laptop, a computer workstation, a tablet computing device, a smartphone, a cellular phone, a mobile phone, a consumer electronic (CE) device having a display, a television (TV), a wearable display, a head mounted display, a digital signage, or an edge device connected to a user's home network or an organization's network.

The database 108 may include suitable logic, interfaces, and/or code that may be configured to store information about the seller 116 and the customer 114, conversation(s) between the customer 114 and the agent, score(s) related to customer's intent to purchase a vehicle, and insight information associated with the conversation(s). In accordance with an embodiment, the database 108 may also store tuned weights of a question answering (QA) machine learning model that the agent may use to chat with the customer 114 in the chat session. The database 108 may be a relational database, a non-relational database, or a set of files in conventional or big-data storage. In an embodiment, the database 108 may be stored or cached on a device, such as the electronic device 102.

In some embodiments, the database 108 may be hosted on a plurality of servers at same or different locations. Operations of the database 108 may be executed using hardware including a processor, a microprocessor (e.g., to perform or control performance of one or more operations), a field-programmable gate array (FPGA), or an application-specific integrated circuit (ASIC). In some other instances, the database 108 may be implemented using software.

The communication network 110 may include a communication medium through which the electronic device 102, the customer device 104, and the display device 106 may communicate with each other. The communication network 110 may include one of a wired connection or a wireless connection. Examples of the communication network 110 may include, but are not limited to, the Internet, a cloud network, a Cellular or Wireless Mobile Network (such as a Long-Term Evolution and 5G New Radio), a Wireless Fidelity (Wi-Fi) network, a Personal Area Network (PAN), a Local Area Network (LAN), or a Metropolitan Area Network (MAN).

Various devices in the network environment 100 may be configured to connect to the communication network 110 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

During operation, the electronic device 102 may control the customer device 104 to render a marketplace UI associated with an online reseller marketplace. The marketplace UI may include the customer UI 104A and the seller UI 106A. In other words, the customer UI 104A may include a version of the marketplace UI that is adapted for the customer device 104. The seller UI 106A may include a version of the marketplace UI that is adapted for the display device 106 associated with the agent (such as the seller 116).

From the customer device 104, the electronic device 102 may receive an input that includes a selection of the vehicle 118 from a listing of vehicles on the marketplace UI. The vehicle 118 may be, for example, a used vehicle or a new vehicle listed on a reseller marketplace (i.e., the marketplace UI). Based on a selection of the vehicle 118, the electronic device 102 may initiate a chat session between the customer 114 associated with the input and an agent associated with the vehicle 118. The agent may be the chatbot 112 or a person such as the seller 116 of the vehicle 118. For a duration of the chat session, the electronic device 102 may record a conversation between the customer 114 and the agent. The conversation may include a set of customer queries associated with the vehicle 118. For example, the customer query may include queries such as “Are you the first owner of the car?”, “Has the car been involved in any accident?”, “What brand of tires are installed in the car?”, and the like.

The electronic device 102 may update a score as a measure of an intent of the customer 114 to purchase the vehicle 118. The score may be updated based on a textual analysis of the conversation. In accordance with an embodiment, the score may be a value between 0 and 1 that a machine learning model (such as a neural network-based language model) may produce based on analysis of the conversation. A value of the score close to 1 May indicate a positive intent (i.e., a serious customer) of the customer 114 to purchase the vehicle 118. Similarly, a value of the score close to 0 May indicate a negative intent (i.e., a non-serious customer) of the customer 114 to purchase the vehicle 118. A value of the score close to 0.5 May indicate a neutral intent of the customer 114 to purchase the vehicle 118. The neutral intent may indicate that the conversation may require more inputs or questions from the customer 114 to provide clarity on the intent.

Based on the updated score, the electronic device 102 may control the display device 106 associated with the agent to render insight information associated with the conversation. For example, the insight information may be a message which states that only 1.3% of customers that mention price early on in the conversation have gone on to purchase the vehicle 118. In accordance with an embodiment, the insight information may be produced by the machine learning model along with the updated score.

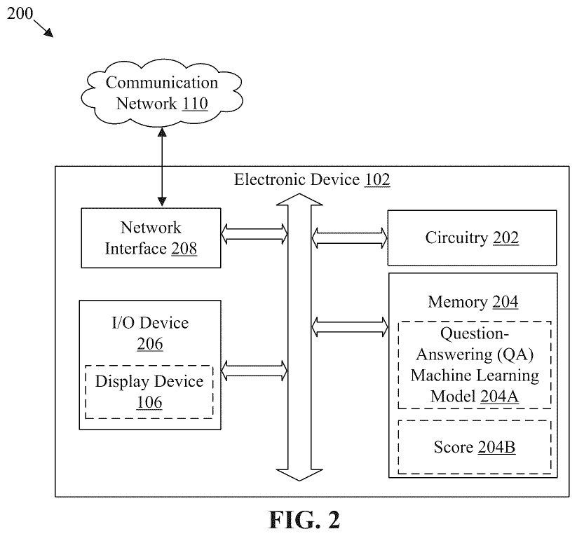

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown a block diagram 200 of the electronic device 102. The electronic device 102 may include circuitry 202, a memory 204, an input/output (I/O) device 206, the display device 106, and a network interface 208. In at least one embodiment, the I/O device 206 may include the display device 106. The memory 204 may store a question-answering (QA) machine learning model 204A and a score 204B. The circuitry 202 may be communicatively coupled to the memory 204, the I/O device 206, and the network interface 208 through wired or wireless communication of the electronic device 102.

A person of ordinary skill in the art will understand that the block diagram 200 of the electronic device 102 may also include other suitable components or systems, in addition to the components or systems which are illustrated herein to describe and explain the function and operation of the present disclosure. Detailed description of such components or systems has been omitted from the disclosure for the sake of brevity.

The circuitry 202 may include suitable logic, circuitry, and/or interfaces code that may be configured to execute program instructions associated with different operations to be executed by the electronic device 102. The circuitry 202 may include any suitable special-purpose or general-purpose computer, computing entity, or processing device including various computer hardware or software modules and may be configured to execute instructions stored on any applicable computer-readable storage media. For example, the circuitry 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. The circuitry 202 may include any number of processors configured to, individually or collectively, perform or direct performance of any number of operations of the display device 106, as described in the present disclosure. Examples of the processor may include a Central Processing Unit (CPU), a Graphical Processing Unit (GPU), an x86-based processor, an x64-based processor, a Reduced Instruction Set Computing (RISC) processor, a Complex Instruction Set Computing (CISC) processor, and/or other hardware processors.

The memory 204 may include suitable logic, circuitry, interfaces, and/or code that may be configured to store the program instructions executable by the circuitry 202. In at least one embodiment, the memory 204 may be further configured to store the QA machine learning model 204A that the agent uses to chat with the customer 114 in the chat session, the conversation between the customer 114 and the agent, the score 204B, and the insight information. Example implementations of the memory 204 may include, but are not limited to, Random Access Memory (RAM), Read Only Memory (ROM), Hard Disk Drive (HDD), a Solid-State Drive (SSD), a CPU cache, and/or a Secure Digital (SD) card.

The QA machine learning model 204A may be a deep learning-based language model that may generate a text such as answers to questions with or without a context (e.g., open-domain QA), or vice versa. The accuracy or efficiency of the generated text may depend on a dataset the QA machine learning model 204A is trained on. An example of such a dataset is a Stanford question answering dataset (SQuAD) dataset or a conversational question answering (CoQA) dataset. Such models need to understand the structure of the language, have a semantic understanding of the context and the questions, have an ability to locate the position of an answer phrase, and much more.

The QA machine learning model 204A may be a neural network model that may be a computational network, or a system of artificial neurons arranged in a plurality of layers. The plurality of layers of the neural network model may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network model. Outputs of each hidden layer may be coupled to inputs of at least one node in other layers of the neural network model. Node(s) in the final layer may receive inputs from at least one hidden layer to output a result. The number of layers and the number of nodes in each layer may be determined from hyper-parameters of the neural network model. Such hyper-parameters may be set before or after training the neural network model on a training dataset.

Each node of the neural network model may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network model. All or some of the nodes of the neural network model may correspond to a same mathematical function or a different mathematical function.

In training of the neural network model, one or more parameters of each node of the neural network may be updated based on whether an output of the final layer for a given input (from the training dataset) matches a correct result based on a loss function for the neural network model. The above process may be repeated for same or a different input until a minima of a loss function is achieved, and a training error is minimized. Several methods for training are known in art, for example, gradient descent, stochastic gradient descent, batch gradient descent, gradient boost, meta-heuristics, and the like.

The neural network model may include electronic data, which may be implemented as, for example, a software component of an application executable on an electronic device (for example, the electronic device 102). The neural network model may rely on libraries, external scripts, or other logic/instructions for execution by a processing device, such as the circuitry 202. The neural network model may include code and routines configured to enable a computing device, such as the circuitry 202 to generate a text such as answers to questions with or without a context (e.g., open-domain QA), or vice versa. Additionally, or alternatively, the classifier model such as neural network model may be implemented using hardware including a processor, a microprocessor (e.g., to perform or control performance of one or more operations), a field-programmable gate array (FPGA), or an application-specific integrated circuit (ASIC). Alternatively, in some embodiments, the neural network model may be implemented using a combination of hardware and software.

The I/O device 206 may include suitable logic, circuitry, interfaces, and/or code that may be configured to receive an input and provide an output based on the received input. The I/O device 206 may include one or more input and output devices that may communicate with different components of the electronic device 102. For example, the I/O device 206 may receive user inputs to trigger execution of program instructions associated with different operations to be executed by the display device 106. Examples of the I/O device 206 may include, but are not limited to, a touch screen, a keyboard, a mouse, a joystick, a microphone, the display device 106, and a speaker.

The network interface 208 may include suitable logic, circuitry, and interfaces that may be configured to facilitate communication between the electronic device 102, the customer device 104, and the display device 106 via the communication network 110. The network interface 208 may be implemented by use of various known technologies to support wired or wireless communication of the electronic device 102 with the communication network 110. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet, or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a near field communication protocol, a wireless pear-to-pear protocol, a protocol for email, instant messaging, and a Short Message Service (SMS).

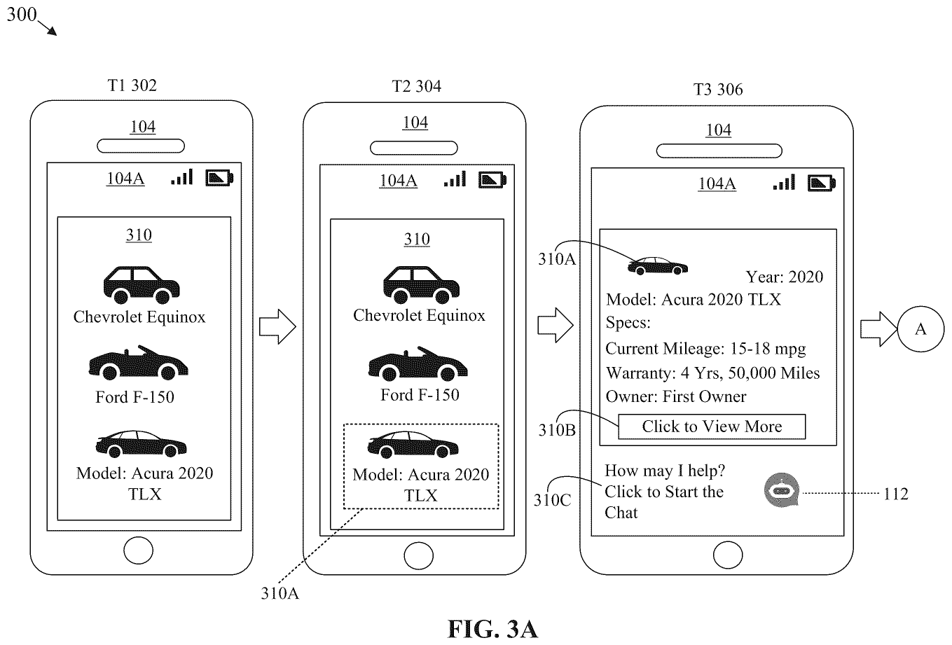

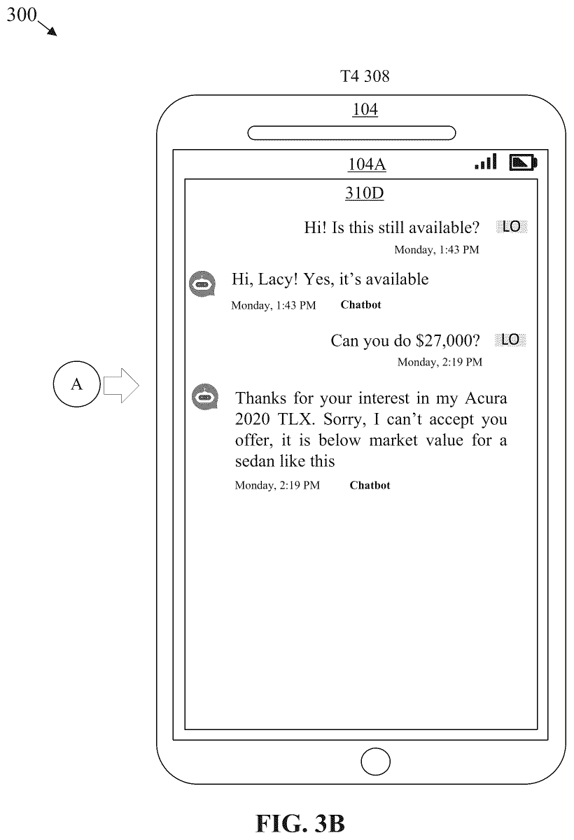

The display device 106 may include suitable logic, circuitry, and interfaces that may be configured to receive, via the UI, selection of the vehicle 118 from a listing of vehicles, initiation of a chat session, and a query associated with the vehicle 118. The display device 106 may be realized through several known technologies such as, but not limited to, at least one of a Liquid Crystal Display (LCD) display, a Light Emitting Diode (LED) display, a plasma display, or an Organic LED (OLED) display technology, or other display devices. Various operations of the circuitry 202 are described further, for example, in FIGS. 3A, 3B, 4A, 4B, 5, and 6.

FIGS. 3A and 3B are diagrams that illustrate exemplary interactions between a customer and an agent associated with a vehicle, in accordance with an embodiment of the disclosure. FIGS. 3A and 3B are explained in conjunction with elements from FIG. 1 and FIG. 2. With reference to FIGS. 3A and 3B, there is shown an exemplary scenario 300.

At T1 302, the circuitry 202 may control the customer device 104 to render a marketplace UI (such as the customer UI 104A) associated with an online reseller marketplace. For example, the customer UI 104A may display UI elements of the online reseller marketplace. The online reseller marketplace may include a listing of vehicles 310, and information associated with the listing of vehicles 310 and respective sellers. For a vehicle in the listing of vehicles 310, the information may include at least one of a specification of features in the vehicle, historical usage details of the vehicle, performance parameters of the vehicle, details of a current owner of the vehicle, warranty and insurance details for the vehicle, price information for the vehicle, and the like. The customer 114 may review the information associated with each vehicle and may select a vehicle from the listing of vehicles 310 for further inquiry.

At T2 304, the circuitry 202 may receive an input from the customer device 104. The input may include a selection of at least one vehicle from the listing of vehicles 310. For example, as illustrated in FIG. 3A, the customer 114 may select a vehicle 310A from the listing of vehicles 310 on the customer UI 104A. The selected vehicle 310A may be highlighted to indicate a selection of the vehicle 310A. As illustrated in the FIG. 3A, the vehicle 310A is “Acura® 200 TLX” that is selected from the listing of vehicles 310. Based on selection of the vehicle 310A, information associated with the selected vehicle 310A may be displayed on the marketplace UI (i.e., customer UI 104A) of the customer device 104.

At T3 306, the circuitry 202 may control the customer device 104 to render information associated with the selected vehicle 310A. As illustrated, the information associated with the selected vehicle 310A may include details such as a model of the vehicle (for example, Acura 2020 TLX), a year of manufacture of the vehicle (for example, 2020), a mileage of the vehicle (for example, 15-18 miles per gallon), a warranty (for example, 4 years and 50,000 miles), an owner type (for example, first owner), the like.

The circuitry 202 may further control the customer device 104 to render a view more option 310B on the customer device 104. If the customer 114 selects the view more option 310B, then further information associated with the selected vehicle 310A may be rendered on the customer device 104. The information associated with the selected vehicle 310A may include, for example, a specification of features in the vehicle (for example, transmission details, on-road performance related information, engine information, the like), historical usage details of the vehicle (for example, average trip durations, usual travel locations, purpose of the trips (such as work commute, off-roading, ranch work, or interstate travel), performance parameters of the vehicle (for example, engine capacity, maximum power, maximum torque, and the like), details of a current owner of the vehicle (for example, name, age, and the like), or price information for the vehicle (for example, 10,000 USD). Further, at T3 306, the circuitry 202 may render an option to start a chat 310C on the customer device 104. If the customer 114 selects the option to start the chat 310C, a chat session 310D may be initiated between the customer 114 and the agent (for example, the chatbot 112 or the seller 116) associated with the selected vehicle 310A.

At T4 308, the circuitry 202 may initiate the chat session 310D between the customer 114 and the agent (for example, the chatbot 112 or a person who may be the seller 116) associated with the selected vehicle 310A. The chat session 310D may be initiated based on the selection of the option of start the chat 310C. The chat session 310D may be setup between the agent and the customer 114 for a duration (for example, an hour, a few hours, few minutes on two or more days of a week, and the like). For the duration of the chat session 310D, a conversation may take place between the agent (for example, the chatbot 112) and the customer 114. The conversation may include a set of customer queries associated with the selected vehicle 310A. For example, the set of customer queries may include a query related to a mileage of the vehicle, a query related to a purchase date of the vehicle, a query related to a usage pattern of the vehicle, and the like.

In an embodiment, the agent may be a person such as the seller 116. The received set of customer queries may be rendered on the display device 106. The seller 116 may view the set of customer queries via the seller UI 106A displayed on the display device 106. The seller 116 may provide replies to the customer queries using the I/O device 206. The customer UI 104A may render such replies on a chat interface (as shown in FIG. 3B).

In another embodiment, the agent may be the chatbot 112. The circuitry 202 may be configured to receive the set of customer queries associated with the selected vehicle 310A. On behalf of the seller 116 of the vehicle 310A, the circuitry 202 may generate a reply to each customer query of the set of customer queries by using the QA machine learning model 204A and information associated with the vehicle 310A on the marketplace UI. Further, the circuitry 202 may control the customer device 104 to render the reply as a part of the conversation. For example, as illustrated in FIG. 3B, the customer 114 may raise a query “Hi, is this still available?”. Based on the received query, the chatbot 112 may use the QA machine learning model 204A to generate a reply “Hi, Lacy! Yes, it's available”. The QA machine learning model 204A may be trained or fine-tuned on the information associated with the vehicle 310A before the start of the chat session 310D. If the customer 114 further raises a query “can you do $27,000?”, then the chatbot 112 may use the QA machine learning model 204A to reply to the query with a response “Thanks for your interest in my Acura 2020 TLX. Sorry, I can't accept your offer, it is below market value for a sedan like this”.

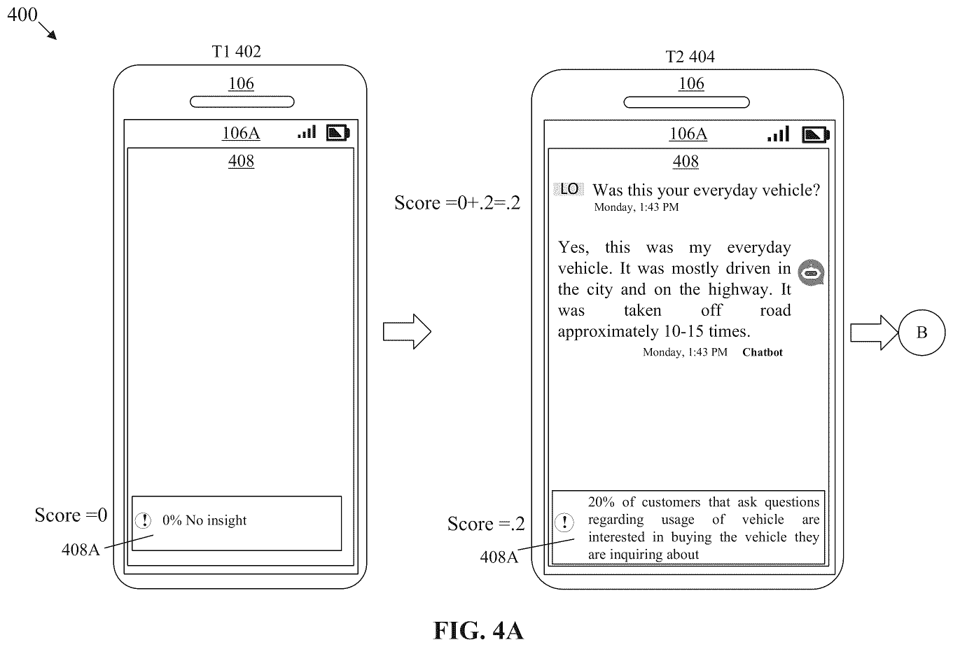

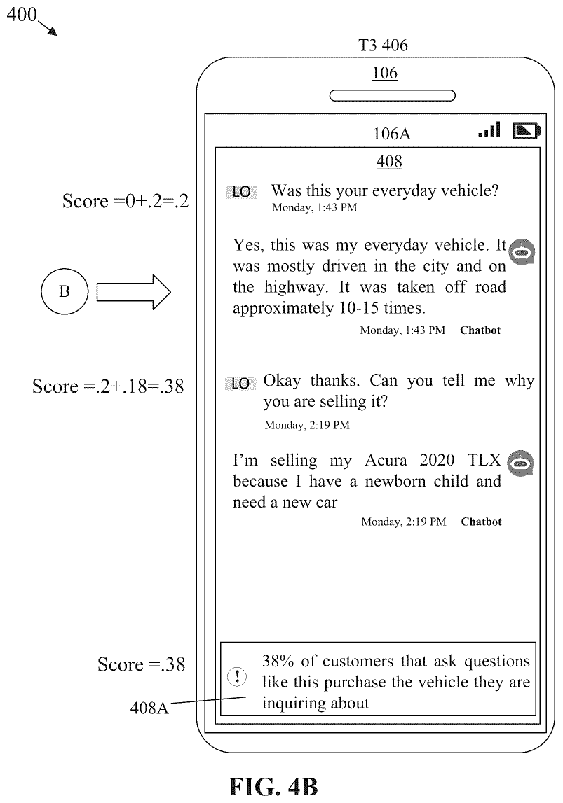

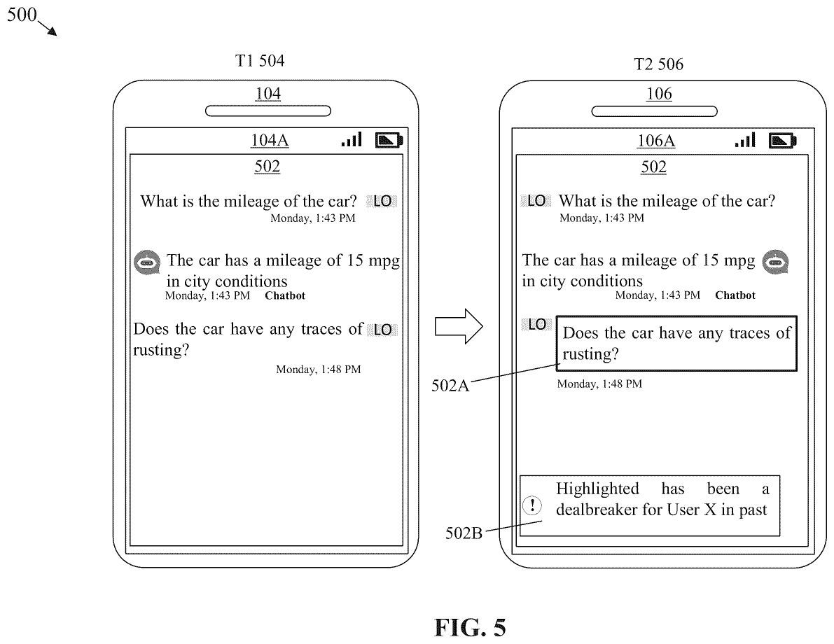

The circuitry 202 may update the score 204B as a measure of an intent of the customer 114 to purchase the vehicle 310A. The score 204B may be updated based on a textual analysis of the conversation between the customer 114 and the agent. Further, the circuitry 202 may control the display device 106 associated with the agent to render insight information associated with the conversation. The insight information may be updated based on the updated score 204B. Examples of the insight information are provided in FIGS. 4A, 4B, and 5. Insight generation is described further, for example, in FIGS. 4A and 4B.

FIGS. 4A and 4B are diagrams that illustrate an exemplary scenario for a display of insight information associated with an exemplary conversation between a customer and an agent, in accordance with an embodiment of the disclosure. FIGS. 4A and 4B are explained in conjunction with elements from FIG. 1, FIG. 2, FIG. 3A, and FIG. 3B. With reference to FIGS. 4A and 4B, there is shown an exemplary scenario 400.

At T1 402, the circuitry 202 may initialize the score 204B with an initial value at a start of a chat session 408. For example, as illustrated in FIG. 4A, the initial value of the score 204B at T1 402 is equal to 0. The circuitry 202 may control the display device 106 associated with the agent (such as the seller 116) to render insight information 408A associated with the conversation. As shown, for example, the insight information 408A may include a message ‘0% No insight’ for the initial score 204B.

At T2 404, a query may be generated via the customer device 104 based an input from the customer 114 in a duration of the chat session 408. The query may be associated with the vehicle 310A (selected in FIG. 3A). As shown, for example, the query includes a text “Was this your everyday vehicle?”. In response to the received query, the circuitry 202 may execute a textual analysis of the conversation between the customer 114 and the agent (such as the chatbot 112). As illustrated, a value for the query may be determined as 0.2 based on the textual analysis. The score 204B may be updated by adding the value (i.e., 0.2) to the initial score 204B of 0. The updated score 204B may be equal to 0.2. A value of the score 204B close to 1 May indicate a positive intent (i.e., a serious customer) of the customer 114 to purchase the vehicle 310A. Similarly, a value of the score 204B close to 0 May indicate a negative intent (i.e., a non-serious customer) of the customer 114 to purchase the vehicle 310A. A value of the score 204B close to 0.5 may indicate a neutral intent of the customer 114 to purchase the vehicle 310A. The score 204B of 0.2 May indicate a negative intent of the customer 114 to purchase the vehicle 310A. Based on the query, the chatbot 112 may generate the insight information 408A using the QA machine learning model 204A. As illustrated, the insight information 408A may include a message “20% of customers that query regarding usage of vehicle are interested in buying the vehicle they are inquiring about”.

The chatbot 112 may use the QA machine learning model 204A to generate a reply to the customer query as “Yes, this was my everyday vehicle. It was mostly driven in the city and on the highway. It was taken off road approximately 10-15 times”. Further, the circuitry 202 may execute the textual analysis of the conversation to categorize each query of the set of customer queries in the conversation into a query type associated with the vehicle 310A. By way of example, and not limitation, the query type may be one of a feature-related query, a price-related query, a query associated with a current owner of the vehicle 310A, a performance-related query, a service-related query, an insurance-related query, or a warranty-related query. The circuitry 202 may further compute a value corresponding to each query of the set of customer queries based on the categorization. The value may indicate a change in the intent of the customer 114 to purchase the vehicle 310A. The score 204B may be updated based on the value for a query and the query type. For example, the value for a price-related query may be different as compared to that for a service-related query.

In the duration of the chat session 408, the score 204B may be updated for a number of iterations based on the computed value for each query of the set of customer queries. The computed score 204B may be proportional to the intent of the customer 114 to purchase the vehicle 310A. The score 204B or the intent of the customer 114 to purchase the vehicle 310A may increase if the computed value for a query is a positive value and may decrease if the computed value is a negative value. For example, in a duration of the conversation, if customer queries are not directed towards the vehicle 310A, then the value for such queries may be given negative values. After update, the score 204B may decrease due to such queries and the intent of the customer 114 to purchase the vehicle 310A may decrease as well.

In accordance with an embodiment, the circuitry 202 may determine at least one of a length of the conversation or a time period that the customer 114 takes in between two consecutive queries of the set of customer queries. The score 204B may be updated further based on the length of the conversation or the time period. For example, if the length of the conversation is more than a predefined limit (e.g., 1 hour), then a higher value (i.e., a positive value that may be greater than an average value per query) may be assigned to the customer query. However, if the length of the conversation is shorter than the predefined limit, then the circuitry 202 may assign a lower value (i.e., a positive value that may be less than an average value per query or a negative value) to the customer query in the duration of the chat session 408. During the conversation, if the customer 114 takes a longer time to respond between two consecutive queries, then the circuitry 202 may assign a lower value to the customer query. However, if the customer 114 takes less time to respond between two consecutive queries, then the circuitry 202 may assign a higher value to the customer query.

In accordance with an embodiment, the circuitry 202 determine an order in which the set of customer queries appear in the conversation. The score 204B may be updated further based on the determined order. For example, if the customer 114 raises a query about a price of the vehicle 310A in an initial phase of the conversation, then the circuitry 202 may assign a lower value to the customer query. However, if the customer 114 raises a query about the history of the vehicle 310A or other details such as a mileage, a purchase year, and so on, then the circuitry 202 may assign a higher value to the customer query.

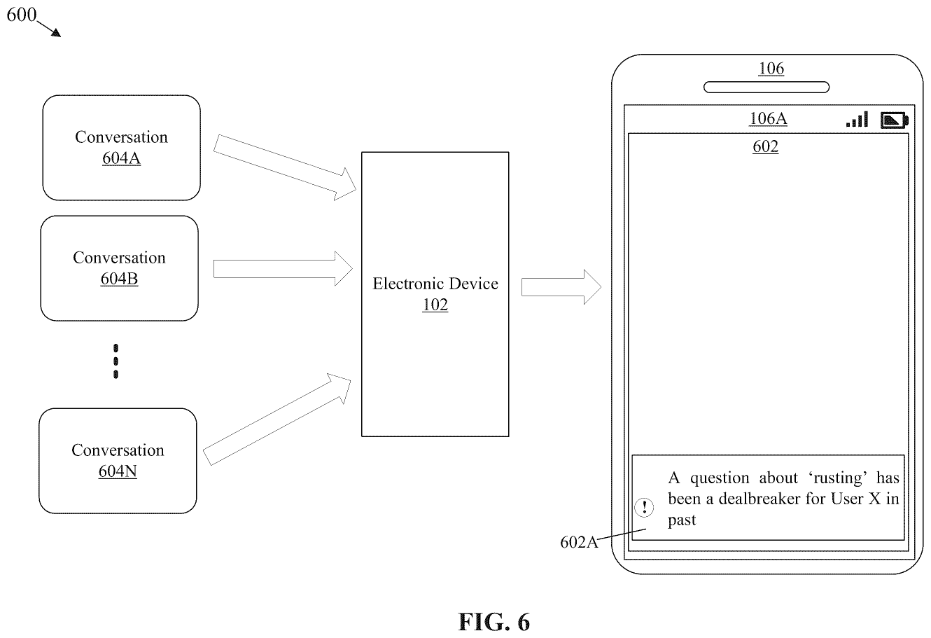

In accordance with an embodiment, the circuitry 202 may further determine a pattern associated with the set of customer queries based on a set of past conversations about the vehicle 310A on the marketplace UI (such as the customer UI 104A). The score 204B may be updated further based on the pattern. Details associated with the pattern are provided, for example, in FIG. 6.

In accordance with an embodiment, the circuitry 202 may categorize the customer 114 into a buyer type based on past conversations of the customer 114 on the marketplace UI (such as the customer UI 104A). The score 204B may be updated further based on the buyer type. By way of example, and not limitation, the buyer type may be one of a price sensitive customer or a feature/performance sensitive customer. The price sensitive customer may be a type of the customer 114 that may provide more weightage to a cost of the vehicle 310A, or a cost of maintenance/insurance as compared to other aspects of the vehicle 310A. The feature/performance sensitive customer may be a type of the customer 114 that may give more weightage to performance, specification, and aesthetic details of the vehicle 310A as compared to other aspects of the vehicle 310A. The value for a query from the customer 114 may be computed further based on a textual analysis of past conversations of the customer 114 on the marketplace UI (such as the customer UI 104A). Details about the textual analysis of past conversations of the customer 114 are provided, for example, in FIG. 5.

At T3 406, the circuitry 202 may receive a query from the customer UI 104A of the customer device 104. For example, the query may include a text “Okay thanks. Can you tell me why you are selling it?”. In response to the received query, the circuitry 202 may execute a textual analysis of the conversation. As illustrated, a value for the query may be determined as 0.18. The score 204B may be updated by adding the value of 0.18 to a previous score of 0.2. The updated score 204B thus obtained may be 0.38. Based on the updated score 204B of 0.38, the circuitry 202 may generate the insight information 408A. As illustrated, the insight information 408A at T3 406 may state that “38% of customers that ask questions like this purchase the vehicle they are inquiring about”. The seller 116 or the chatbot 112 may reply to the customer query via the seller UI 106A stating that “I'm selling my Acura 2020 TLX because I have a newborn child and need a new car”.

FIG. 5 is a diagram that illustrates an exemplary scenario for generation of insight information, in accordance with an embodiment of the disclosure. With reference to FIG. 5, there is shown an exemplary scenario 500. The exemplary scenario 500 is described in conjunction with elements from FIG. 1, FIG. 2, FIG. 3A, FIG. 3B, FIG. 4A, and FIG. 4B. With reference to FIG. 5, there is shown an exemplary scenario 500.

At T1 504, the circuitry 202 may receive a query from the customer UI 104A of the customer device 104. For example, the query may include a text “What is the mileage of the car?”. Based on the received query, the agent (such as the chatbot 112), at T2 506, may use the QA machine learning model 204A to reply to the query with a response “The car has a mileage of 15 mpg in city conditions”. In the duration of the chat session 502 (i.e., at T1 504), the customer 114 may raise a query “Does the car have any traces of rusting?”, as shown. The circuitry 202 may execute a textual analysis of the past conversations of the customer 114. Based on the textual analysis, insight information 502B may be generated at T2 506 to include a message “Highlighted has been a dealbreaker for User X in past”. For example, from the past conversations of the customer 114, it may be determined that the customer 114 drops from the conversation if the customer 114 finds out that the vehicle 310A has a rust problem. The seller 116 or the chatbot 112 may render an appropriate reply to the query related to the rust problem.

FIG. 6 is a diagram that illustrates an exemplary scenario for display of insight information based on past conversations of a customer, in accordance with an embodiment of the disclosure. FIG. 6 is explained in conjunction with elements from FIG. 1, FIG. 2, FIG. 3A, FIG. 3B, FIG. 4, and FIG. 5. With reference to FIG. 6, there is shown an exemplary scenario 600.

The circuitry 202 may receive past conversations (such as a conversation 604A, a conversation 604B . . . , and a conversation 604N) stored in the database 108 or the memory 204. The circuitry 202 may perform a textual analysis of the past conversations. Based on the textual analysis of the past conversations, the circuitry 202 may determine a pattern associated with the set of customer queries about the vehicle 310A on the marketplace UI. The pattern may indicate that the customer 114 is particular about a certain aspect of the vehicle 310A. For example, it may be determined from the past conversations that the customer 114 is sensitive to an amount of rust on the vehicle 310A and may not continue the conversation if the amount of rust on the vehicle 310A is significant. Therefore, as the customer 114 initiates the chat session 602, the circuitry 202 may generate insight information 602A based on the pattern and the past conversations. After the generation, the insight information 602A may be rendered on the display device 106. As illustrated, for example, the insight information 602A include a message “A question about rusting has been a dealbreaker for User X in past”. All the conversations of the customer 114 and the agent (such as the seller 116) may be stored on the database 108 or the memory 204. In an embodiment, the insight information 602A may be displayed at the start of the chat session 602. In another embodiment, the insight information 602A may include a highlight effect on the dealbreaker question during the chat session 602.

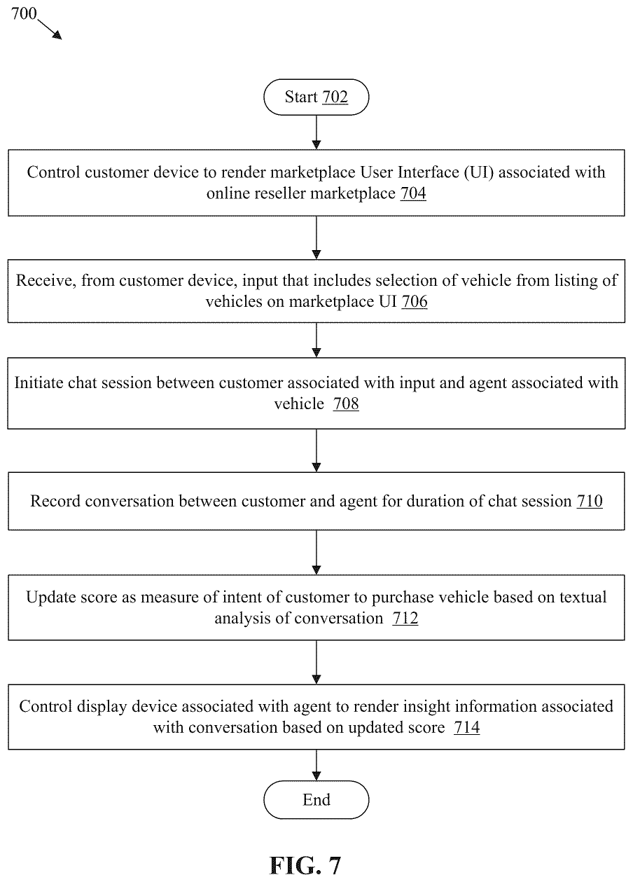

FIG. 7 is a flowchart that illustrates exemplary operations for understanding customer's intent, in accordance with an embodiment of the disclosure. The flowchart 700 is described in conjunction with FIGS. 1, 2, 3A, 3B, 4A, 4B, 5, and 6. The operations from 702 to 714 may be implemented, for example, by the electronic device 102 of FIG. 1 or the circuitry 202 of FIG. 2. The operations of the flowchart 700 may start at 702 and proceed to 704.

At 704, the customer device 104 to render a marketplace UI associated with an online reseller marketplace may be controlled. In one or more embodiments, the circuitry 202 may be configured to control the customer device 104 to render the marketplace UI. Details about the control of the customer device 104 to render a marketplace User Interface (UI) associated with an online reseller marketplace are provided, for example, in FIG. 3A.

At 706, an input that includes selection of vehicle 310A from listing of vehicles 310 on marketplace UI may be received from the customer device 104. In one or more embodiments, the circuitry 202 may be configured to receive from the customer device 104, input that includes selection of vehicle 310A from listing of vehicles 310 on marketplace UI. Details about the selection of the vehicle 310A from listing of vehicles 310 are provided, for example, in FIG. 3A.

At 708, the chat session 310D between the customer 114 associated with input and agent (such as the chatbot 112 or the seller 116) associated with vehicle 310A may be initiated. In one or more embodiments, the circuitry 202 may be configured to Initiate chat session 310D between customer 114 associated with input and agent associated with vehicle 310A. Details about the chat session 310D initiation are provided, for example, in FIG. 3B.

At 710, conversation between the customer 114 and agent (such as the chatbot 112 or the seller 116) for duration of chat session 310D may be recorded. In one or more embodiments, the circuitry 202 may be configured to record conversation between the customer 114 and the agent (such as the chatbot 112 or the seller 116) for duration of the chat session 310D.

At 712, the score 204B as measure of intent of the customer 114 to purchase the vehicle 310A may be updated based on textual analysis of conversation. In one or more embodiments, the circuitry 202 may be configured to update the score 204B as measure of intent of the customer 114 to purchase the vehicle 310A based on textual analysis of conversation. Details about updating of the score 204B as measure of intent of the customer 114 to purchase the vehicle 310A are provided, for example, in FIGS. 4A and 4B.

At 714, the display device 106 associated with the agent (such as the chatbot 112 or the seller 116) to render insight information associated with conversation based on the updated score 204B may be controlled. In one or more embodiments, the circuitry 202 may be configured to control the display device 106 associated with the agent (such as the chatbot 112 or the seller 116) to render insight information (as shown in FIG. 4A, FIG. 4B, FIG. 5, and FIG. 6) associated with conversation based on the updated score 204B. Control may pass to the end.

Various embodiments of the disclosure may provide a non-transitory, computer-readable medium and/or storage medium, and/or a non-transitory machine readable medium and/or storage medium stored thereon, a set of instructions executable by a machine and/or a computer (such as the electronic device 102). The set of instructions may be executable by the machine and/or the computer to perform operations that may include controlling the customer device 104 to render a marketplace User Interface (UI) associated with an online reseller marketplace and receiving, from the customer device 104, an input that includes a selection of a vehicle 310A from a listing of vehicles 310 on the marketplace UI. The operations may further include initiating the chat session 310D between the customer 114 associated with the input and the agent associated with the vehicle 118. The operations may further include recording a conversation between the customer 114 and the agent (such as the chatbot 112 or the seller 116) for a duration of the chat session 310D. The conversation may include a set of customer queries associated with the vehicle 310A. Thereafter, the operations may include updating the score 204B as a measure of an intent of the customer 114 to purchase the vehicle 310A based on a textual analysis of the conversation and controlling the display device 106 associated with the agent (such as the chatbot 112 or the seller 116) to render insight information associated with the conversation. The insight information may be rendered based on the updated score 204B.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments that fall within the scope of the appended claims.

What is claimed is:

1. An electronic device, comprising:
circuitry that:
controls a customer device to render a marketplace User Interface (UI) associated with an online reseller marketplace;
receives, from the customer device, an input that includes a selection of a vehicle from a listing of vehicles on the marketplace UI;
initiates a chat session between a customer associated with the input and an agent associated with the vehicle;
records a conversation between the customer and the agent for a duration of the chat session, wherein the conversation includes a set of customer queries associated with the vehicle;
updates a score as a measure of an intent of the customer to purchase the vehicle based on a textual analysis of the conversation; and
controls a display device associated with the agent to render insight information associated with the conversation based on the updated score.

2. The electronic device according to claim 1, wherein the agent is a chatbot or a person who is a seller of the vehicle.

3. The electronic device according to claim 1, wherein the agent uses a Question-Answering (QA) machine learning model to chat with the customer in the chat session.

4. The electronic device according to claim 3, wherein the circuitry further:
receives the set of customer queries associated with the vehicle;
generates, on behalf of a human seller of the vehicle, a reply to each customer query of the set of customer queries by using the QA machine learning model and information associated with the vehicle on the marketplace UI; and
controls the customer device to render the reply as a part of the conversation.

5. The electronic device according to claim 3, wherein the circuitry further receives information associated with the vehicle from the marketplace UI, and the information comprises at least one of a specification of features in the vehicle, historical usage details of the vehicle, performance parameters of the vehicle, details of a current owner of the vehicle, warranty and insurance details for the vehicle, or price information for the vehicle.

6. The electronic device according to claim 5, wherein the QA machine learning model is trained using the received information prior to the initiation of the chat session.

7. The electronic device according to claim 1, wherein the circuitry further:
initializes the score with an initial value at a start of the chat session;
executes the textual analysis to categorize each query of the set of customer queries in the conversation into a query type associated with the vehicle; and
computes a value corresponding to each query of the set of customer queries based on the categorization,
wherein the value indicates a change in the intent of the customer to purchase the vehicle, and
the score is updated for a number of iterations based on the computed value for each query of the set of customer queries.

8. The electronic device according to claim 7, wherein the value is computed further based on a textual analysis of past conversations of the customer on the marketplace UI.

9. The electronic device according to claim 7, wherein the score as the measure of the intent of the customer to purchase the vehicle increases if the computed value is a positive value.

10. The electronic device according to claim 7, wherein the score as the measure of the intent of the customer to purchase the vehicle decreases if the computed value is a negative value.

11. The electronic device according to claim 7, wherein the query type is at least one of a feature-related query, a price-related query, a query associated with a current owner of the vehicle, a performance-related query, a service-related query, an insurance-related query, or a warranty-related query.

12. The electronic device according to claim 1, wherein the circuitry further determines at least one of a length of the conversation or a time period that the customer takes in between two consecutive queries in the set of customer queries, and
wherein the score is updated further based on the length of the conversation or the time period.

13. The electronic device according to claim 1, wherein the circuitry further determines an order in which the set of customer queries appear in the conversation, and
wherein the score is updated further based on the determined order.

14. The electronic device according to claim 1, wherein the circuitry further determines a pattern associated with the set of customer queries based on a set of past conversations about the vehicle on the marketplace UI, and
wherein the score is updated further based on the pattern.

15. The electronic device according to claim 1, wherein the circuitry further categorizes the customer into a buyer type based on past conversations of the customer on the marketplace UI, and
wherein the score is updated further based on the buyer type.

16. A method, comprising:
in an electronic device:
controlling a customer device to render a marketplace User Interface (UI) associated with an online reseller marketplace;
receiving, from the customer device, an input that includes a selection of a vehicle from a listing of vehicles on the marketplace UI;
initiating a chat session between a customer associated with the input and an agent associated with the vehicle;
recording a conversation between the customer and the agent for a duration of the chat session, wherein the conversation includes a set of customer queries associated with the vehicle;
updating a score as a measure of an intent of the customer to purchase the vehicle based on a textual analysis of the conversation; and
controlling a display device associated with the agent to render insight information associated with the conversation based on the updated score.

17. The method according to claim 16, wherein the agent is a chatbot or a person who is a seller of the vehicle.

18. The method according to claim 16, wherein the agent uses a QA machine learning model to chat with the customer in the chat session.

19. A non-transitory computer-readable medium having stored thereon, computer-executable instructions which, when executed by an electronic device, cause the electronic device to execute operations, the operations comprising:
controlling a customer device to render a marketplace User Interface (UI) associated with an online reseller marketplace;
receiving, from the customer device, an input that includes a selection of a vehicle from a listing of vehicles on the marketplace UI;
initiating a chat session between a customer associated with the input and an agent associated with the vehicle;
recording a conversation between the customer and the agent for a duration of the chat session, wherein the conversation includes a set of customer queries associated with the vehicle;
updating a score as a measure of an intent of the customer to purchase the vehicle based on a textual analysis of the conversation; and
controlling a display device associated with the agent to render insight information associated with the conversation based on the updated score.

20. The non-transitory computer-readable medium according to claim 19, wherein the agent is a chatbot or a person who is a seller of the vehicle.
